(19) United States
(12) Patent Application Publication
(10) Pub. No.: US 2015/0035762 A1
(43) Pub. Date: Feb. 5, 2015

(54) ELECTRONIC DEVICE AND PAIRING METHOD THEREOF

(71) Applicant: Li-Sheng Lu, Taichung City (TW)

(72) Inventor: Li-Sheng Lu, Taichung City (TW)

(73) Assignee: WINTEK CORPORATION, Taichung City (TW)

(21) Appl. No.: 14/166,807

(22) Filed: Jan. 28, 2014

(30) Foreign Application Priority Data
Jul. 31, 2013 (TW) 102127518

(51) Int. Cl. G06F 3/041; H04W 8/00

(52) U.S. Cl. CPC G06F 3/041; H04W 8/005
USPC 345/173

(57) ABSTRACT

An electronic device and a pairing method including following steps are provided. A first touch operation performed on a first touch unit of a first electronic device is detected, and a first azimuth angle of a first pointing direction (defined by the first touch operation) with respect to a reference direction is obtained. The first azimuth angle is compared with a second azimuth angle to obtain an included angle between the first pointing direction and a second pointing direction. When a value obtained by subtracting 180 degrees from an absolute value of the included angle is smaller than a threshold, a pairing relationship is established between the first and second electronic devices. The second azimuth angle is an azimuth angle of the second pointing direction (defined by a second touch operation performed on a second touch unit of the second electronic device) with respect to the reference direction.

### CROSS-REFERENCE TO RELATED APPLICATION

This application claims the priority benefit of Taiwan application serial no. 102127518, filed on Jul. 31, 2013. The entirety of the above-mentioned patent application is hereby incorporated by reference herein and made a part of this specification.

### BACKGROUND OF THE INVENTION

1. Field of the Invention

The invention is related to a pairing method applied between electronic devices, and particularly to an electronic device and a pairing method for establishing a pairing relationship between electronic devices according to a point operation of a user.

2. Description of Related Art

In current information era, human beings by degrees tend to rely on consumers' electronic products. To comply with the requirements for convenience and diversity, various consumers' electronic products are often equipped with network communication interfaces, such that users are able to send messages or information to other electronic products through the network communication interfaces. At present social or home gatherings, almost everyone has smart phone, mobile communication device, or tablet PC. In such meetings or gatherings, if the electronic devices within a short range may be connected through wireless network, the electronic devices may be utilized in a more practical manner. For instance, the electronic devices may transmit documents, pictures, and other files or deliver messages through the wireless network.

Generally, prior to message delivery or data transmission among the electronic devices, the pairing relationship among the electronic devices is required to be established through the communication interfaces. Users need to spend time on browsing the menu, selecting the to-be-connected electronic device, and manually inputting the name or other network device information of the target electronic device. If any error occurs in the process of inputting the pairing information, all the steps for establishing the wireless network connection must be performed again, which is rather inconvenient for the users. In addition, since the electronic devices have become more and more diverse and common, if a number of electronic devices that support the same wireless communication protocol are within an effective transmission range, the issue of erroneous pairing may arise. In short, users of electronic devices who intend to communicate with other electronic devices frequently suffer from the complicated steps of connecting to and pairing with other electronic devices.

### SUMMARY OF THE INVENTION

The invention is directed to an electronic device and a pairing method thereof. Since a pairing relationship between electronic devices is established by means of a point operation of a user, steps of establishing said pairing relationship are significantly simplified, and the use of the electronic device is facilitated.

In an embodiment of the invention, a pairing method of electronic devices is provided. The pairing method includes following steps. A first touch operation performed on a first touch unit of a first electronic device is detected, and a first azimuth angle of a first pointing direction with respect to a reference direction is obtained. Here, the first pointing direction is defined by the first touch operation. The first azimuth angle and a second azimuth angle are compared to obtain an included angle between the first pointing direction and a second pointing direction. If a value obtained by subtracting 180 degrees from an absolute value of the included angle is smaller than a threshold, a pairing relationship is established between the first electronic device and a second electronic device. The second azimuth angle is an azimuth angle of the second pointing direction with respect to the reference direction, and the second pointing direction is defined by the second touch operation performed on a second touch unit of the second electronic device.

According to an embodiment of the invention, the step of detecting the first touch operation performed on the first touch unit and obtaining the first azimuth angle of the first pointing direction with respect to the reference direction includes: detecting a touch point of the first touch operation; obtaining the first pointing direction defined by the touch point of the first touch operation and a reference point; calculating the first azimuth angle of the first pointing direction with respect to the reference direction.

According to an embodiment of the invention, the step of detecting the first touch operation performed on the first touch unit and obtaining the first azimuth angle of the first pointing direction with respect to the reference direction includes: detecting a drag operation of the first touch operation. Here, the drag operation includes a start point and an end point. Besides, the first pointing direction defined by the start point and the end point is obtained. The first azimuth angle of the first pointing direction with respect to the reference direction is calculated.

According to an embodiment of the invention, before the step of comparing the first azimuth angle with the second azimuth angle to obtain the included angle between the first pointing direction and the second pointing direction and establishing the pairing relationship between the first electronic device and the second electronic device if the value obtained by subtracting 180 degrees from the absolute value of the included angle is smaller than the threshold, the pairing method further includes: receiving the second azimuth angle of the second electronic device.

According to an embodiment of the invention, the step of comparing the first azimuth angle with the second azimuth angle to obtain the included angle between the first pointing direction and the second pointing direction and establishing the pairing relationship between the first electronic device and the second electronic device if the value obtained by subtracting 180 degrees from the absolute value of the included angle is smaller than the threshold includes: transmitting the first azimuth angle to a remote server, wherein the remote server compares the first azimuth angle with the second azimuth angle to obtain the included angle between the first pointing direction and the second pointing direction. If the value obtained by subtracting 180 degrees from the absolute value of the included angle is smaller than the threshold, pairing information of the second electronic device is received from the remote server, and the pairing relationship between the first electronic device and the second electronic device is established according to the pairing information.

According to an embodiment of the invention, the pairing method further includes: detecting a third touch operation performed on the first touch unit and obtaining a third azimuth angle of a third pointing direction with respect to the reference direction, wherein the third pointing direction is defined by the third touch operation. The third azimuth angle is compared with a fourth azimuth angle to obtain another included angle between the third pointing direction and a fourth pointing direction. If a value obtained by subtracting 180 degrees from an absolute value of said another included angle is smaller than the threshold, another pairing relationship between the first electronic device and a third electronic device is established. The fourth azimuth angle is an azimuth angle of the fourth pointing direction with respect to the reference direction, and the fourth pointing direction is defined by a fourth touch operation performed on a third touch unit of the third electronic device.

According to an embodiment of the invention, the threshold is greater than or equal to 20 degrees and smaller than or equal to 30 degrees.

From another aspect, in an embodiment of the invention, an electronic device including an azimuth sensor, a touch unit, a processor, and a communication module is provided. The azimuth sensor is configured to sense a reference direction, and the touch unit is configured to detect a first touch operation performed on the touch unit. The processor is coupled to the touch unit and the azimuth sensor. Besides, the processor obtains a first azimuth angle of a first pointing direction with respect to a reference direction, and the first pointing direction is defined by the first touch operation. The processor also compares the first azimuth angle with a second azimuth angle to obtain an included angle between the first pointing direction and a second pointing direction. The communication module is coupled to the processor. If a value obtained by subtracting 180 degrees from an absolute value of the included angle is smaller than a threshold, the processor controls the communication module to establish a pairing relationship between the electronic device and a second electronic device. The second azimuth angle is an azimuth angle of the second pointing direction with respect to the reference direction, and the second pointing direction is defined by the second touch operation performed on a second touch unit of the second electronic device.

As discussed above, according to the pairing method of the electronic devices described herein, after the touch operation containing the point information is performed on the electronic device, the electronic device is capable of recognizing the correct target electronic device and automatically establishing the pairing relationship with the target electronic device, and thereby data may be transmitted between the electronic device described herein and the correct target electronic device through wireless network. Thereby, steps of connecting one electronic device to other electronic devices and pairing the electronic device described herein with other electronic devices may be significantly simplified, erroneous connection and pairing may be prevented, and a user of the electronic device described herein is able to communicate with other electronic devices in an intuitive and convenient manner.

For a more complete understanding of the features and advantages of the present invention, several exemplary embodiments accompanied with figures are detailed described in below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A is a block view illustrating an electronic device according to an embodiment of the invention.

FIG. 1B is a schematic view illustrating establishment of a pairing relationship between electronic devices according to an embodiment of the invention.

FIG. 2 is a flowchart illustrating a pairing method of electronic devices according to an embodiment of the invention.

FIG. 3A exemplarily illustrates a pairing method of electronic devices according to an embodiment of the invention.

FIG. 3B exemplarily illustrates an electronic device in different status.

FIG. 3C exemplarily illustrates a pairing method of electronic devices according to another embodiment of the invention.

FIG. 4 is a flowchart illustrating a pairing method of electronic devices according to another embodiment of the invention.

FIG. 5 exemplarily illustrates a pairing method of electronic devices according to another embodiment of the invention.

FIG. 6 is a flowchart illustrating a pairing method of electronic devices according to yet another embodiment of the invention.

FIG. 7 exemplarily illustrates a pairing method of electronic devices according to yet another embodiment of the invention.

FIG. 8 is a flowchart illustrating a pairing method of electronic devices according to yet another embodiment of the invention.

FIG. 9 exemplarily illustrates a pairing method of electronic devices according to yet another embodiment of the invention.

### DETAILED DESCRIPTION OF DISCLOSED EMBODIMENTS

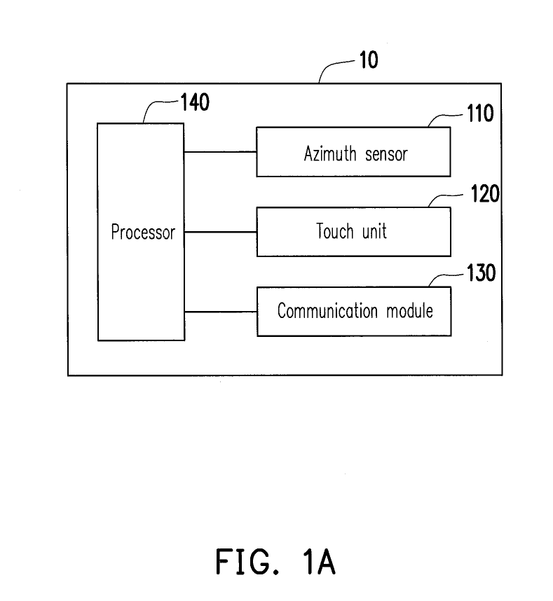

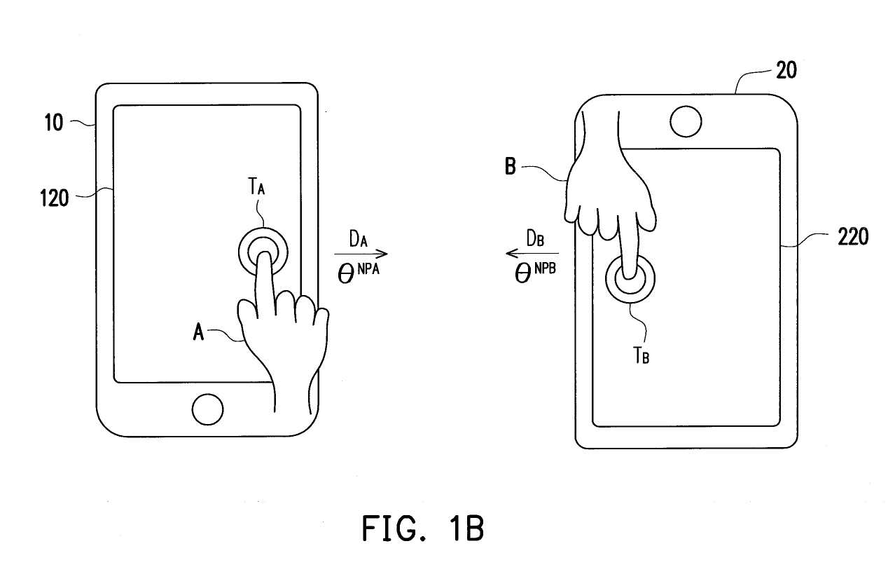

FIG. 1A is a block view illustrating an electronic device according to an embodiment of the invention. With reference to FIG. 1A, the first electronic device 10 includes an azimuth sensor 110, a touch unit 120, a communication module 130, and a processor 140. According to the present embodiment, the first electronic device 10 may be a cell phone, a smart phone, a personal digital assistant (PDA), a tablet PC, a digital camera, an electronic book, a game player, or any other electronic device with touch panel. The invention is not limited thereto. The azimuth sensor 110 includes but is not limited to a gyro meter and an e-compass, for instance. Besides, the azimuth sensor 110 serves to detect the azimuth of the first electronic device 10. Here, the azimuth refers to a direction at which a front end of the first electronic device 10 points. The front end of the first electronic device 10 is the top of the first electronic device 10 when a user observes an image displayed on a screen of the first electronic device 10. That is, the azimuth sensor 110 may detect the actual direction of east, west, north, or south.

The touch unit 120 serves to receive the touch operation input to the touch unit 120 by a user. Here, the touch unit 120 may be a touch panel on the first electronic device 10 or a touch screen containing a touch panel and a display screen. The touch panel may be a resistant touch panel, a capacitive touch panel, a sonic-wave touch panel, an infrared touch panel, or an electromagnetic sensing panel, which should not be construed as a limitation to the invention. The touch screen is a combination of the touch panel and a screen and is also able to sense the touch operation performed on the touch screen by the user. Here, the touch operation refers to a drag operation, a click operation, and so on.

The communication module 130 serves to establish wireless connection. Since the communication module 130 is capable of providing the network communication function, the first electronic device 10 may be connected to other electronic devices through wireless network for data transmission. The wireless network may be wireless wide area network (WAN) that may support long-distance communication, e.g., 3G network or 4G network. Alternatively, the wireless network may allow short-range communication; for instance, the wireless network may include wireless personal area network (WPAN) established according to the IEEE 802.15 standard or wireless local area network (WLAN) established according to the IEEE 802.11 standard. The invention is not limited thereto.

Namely, the communication module 130 may support the 3G wireless communication technology, the Bluetooth WPAN technology, or the wireless fidelity (Wi-Fi) WLAN technology, and the invention is not limited thereto. Besides, the communication module 130 may include one or more devices that can support different types of communication technologies.

The processor 130 is coupled to the azimuth sensor 110, the touch unit 120, and the communication module 130. Here, the processor 130 is, for instance, a central processing unit (CPU), a programmable microprocessor, a digital signal processor (DSP), a programmable controller, an application specific integrated circuit (ASIC), a programmable logic device (PLD), or any other hardware capable of computation.

FIG. 1B is a schematic view illustrating establishment of a pairing relationship between electronic devices according to an embodiment of the invention. With reference to FIG. 1B, in the present embodiment, the structure of the second electronic device 20 is identical or similar to the first electronic device 10, and thus no further description is provided herein. As shown in FIG. 1B, in the present embodiment, the touch unit 120 is assumed to be a touch screen. The first electronic device 10 receives a touch operation T_{A} on the touch screen 120 by a user A (i.e., the user A performs a click operation on the touch screen 120); according to the information relevant to the touch operation T_{A}, the first electronic device 10 is able to obtain a pointing direction D_{A}. The mobile electronic device 20 receives a touch operation T_{B} on the touch screen 220 by a user B (i.e., the user B performs a click operation on the touch screen 220); according to the information relevant to the touch operation T_{B}, the mobile electronic device 20 is able to obtain a pointing direction D_{B}. When the pointing direction D_{A} of the first electronic device 10 and the pointing direction D_{B} of the second electronic device 20 are substantially toward each other, the first and second electronic devices 10 and 20 spontaneously establish the pairing relationship therebetween. Thereby, the first and second electronic devices 10 and 20 may be connected through wireless communication according to the established pairing relationship, and the users are no longer required to manually pair the first and second electronic devices 10 and 20.

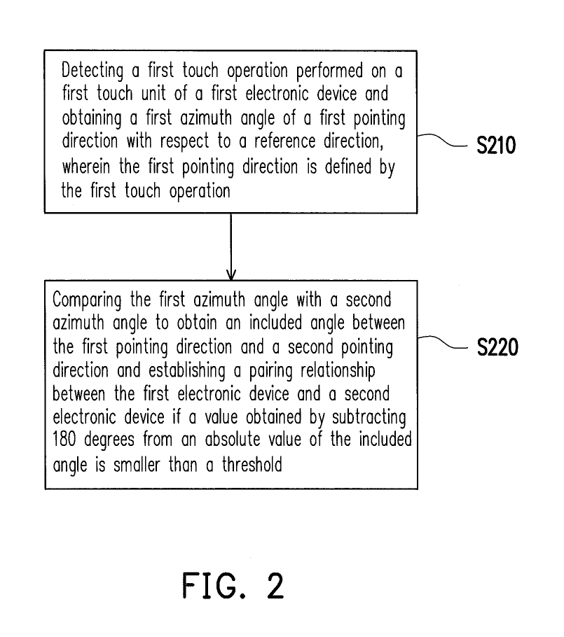

FIG. 2 is provided below to further describe the method for establishing the pairing relationship between the first and second electronic devices 10 and 20 according to the touch operation input by the users. Specifically, FIG. 2 is a flowchart illustrating a pairing method of an electronic device according to an embodiment of the invention. As shown in FIG. 1A, FIG. 1B, and FIG. 2, the detailed steps of the pairing method are elaborated below with reference to the descriptions of components in the first electronic device 10.

In step S210, the touch unit 120 detects a first touch operation performed on the touch unit 120 of the first electronic device 10, and the processor 140 obtains a first azimuth angle of the first pointing direction D_{A} with respect to a reference direction. Here, the first pointing direction D_{A} is defined by the first touch operation. Through the first pointing direction D_{A} defined by the first touch operation, the first electronic device 10 is able to identify the to-be-paired target. Particularly, if an azimuth angle of a pointing direction (defined by a touch operation) with respect to a reference direction may be obtained, it can be determined whether there is a proper to-be-paired electronic device according to the azimuth angle. Hence, in the present embodiment, the processor 140 further calculates and obtains the first azimuth angle of the first pointing direction D_{A} with respect to the reference direction according to the information relevant to the first touch operation. It should be mentioned that the first touch operation may be a click operation (with the point-like touch trajectory) or a drag operation (with the line-like touch trajectory), which should not be construed as a limitation to the invention. Besides, the first azimuth angle may be an angle based on a reference direction (e.g., north) of the reference direction, and the invention is not limited thereto.

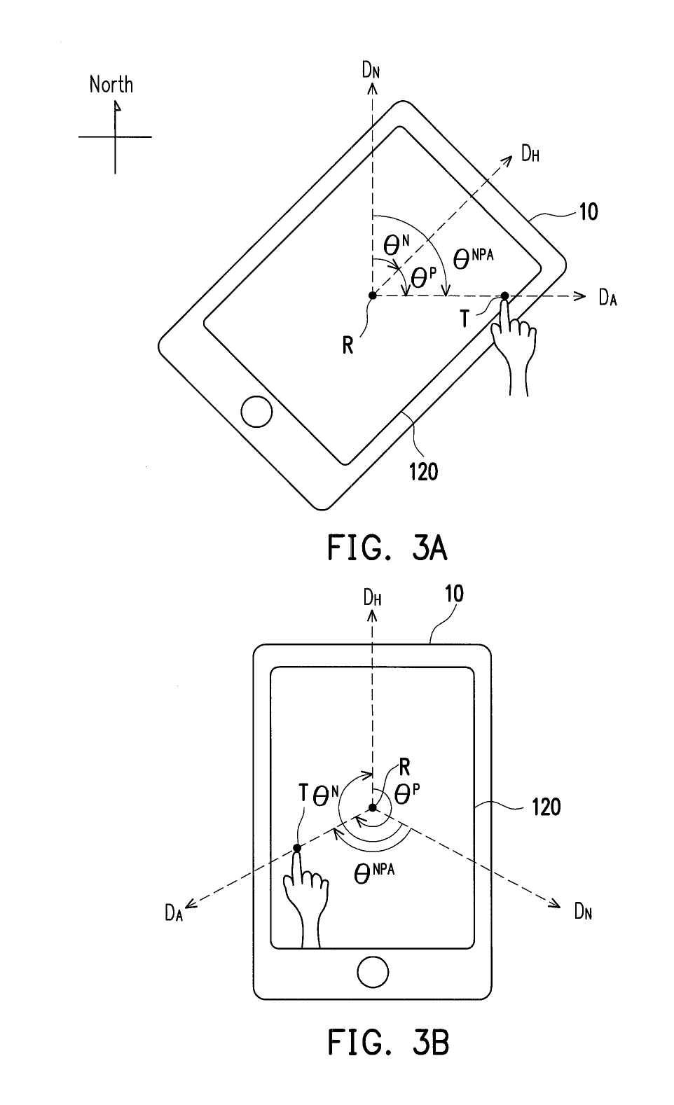

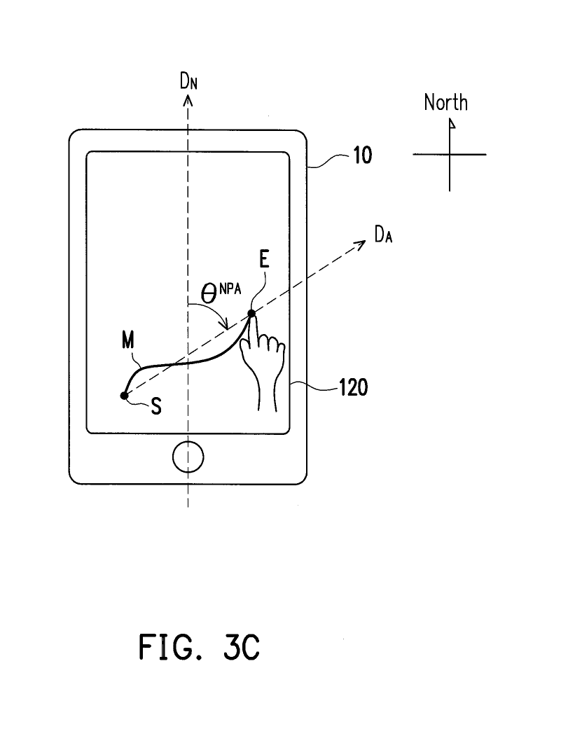

FIG. 3A exemplarily illustrates a pairing method of electronic devices according to an embodiment of the invention. With reference to FIG. 1A and FIG. 3A, in the present embodiment, the touch unit 120 of the first electronic device 10 is a touch screen for detecting the touch point T of the first touch operation. In brief, when a user clicks the touch point T on the touch screen 120 through his or her finger or a stylus, the processor 140 is able to determine the first touch operation to be a click operation on the touch point T.

The processor 140 then obtains the first pointing direction D_{A} defined by the touch point T of the first touch operation and a reference point R. In detail, through the azimuth sensor 110 of the first electronic device 10, a reference direction D_{N} of a reference direction may be obtained. In the present embodiment, the reference direction D_{N} is assumed to face true north, and the reference point R is the center point of the touch screen 120. However, the invention is not limited thereto. Besides, through the azimuth sensor 110 of the first electronic device 10, the direction D_{H} at which the front end of the first electronic device 10 points may also be obtained. An included angle θ^{N} between the direction D_{H} and the reference direction D_{N} may then be calculated. A definition of the included angle θ^{N} is an angle calculated clockwise from the reference direction D_{N} to the direction D_{H}. For instance, if the direction D_{H} at which the front end of the first electronic device 10 points is true east, the included angle θ^{N} is 90 degrees. Moreover, according to the coordinate information of the touch point T and the reference point R, the processor 140 is able to obtain the first pointing direction D_{A} defined by the touch point T and the reference point R, so as to further calculate the included angle θ^{P} between the first pointing direction D_{A} and the direction D_{H} at which the front end of the first electronic device 10 points. A definition of the included angle θ^{P} is an angle calculated clockwise from the direction D_{H} to the first pointing direction D_{A}.

After that, the processor 140 calculates a first azimuth angle θ^{NPA} of the first pointing direction D_{A} with respect to the reference direction. As shown in FIG. 3A, the first azimuth angle θ^{NPA} contains the included angle θ^{N} and the included angle θ^{P}. Namely, after the first electronic device 10 obtains the included angle θ^{N} and the included angle θ^{P}, the first electronic device 10 may add the included angle θ^{N} and the included angle θ^{P} together, so as to obtain the first azimuth angle θ^{NPA} between the first pointing direction D_{A} and the reference direction D_{N} (north). In view of the above, as long as the user performs the click operation, an azimuth angle of the corresponding pointing direction (defined by a touch point of the click operation and a reference point) may be obtained.

FIG. 3B exemplarily illustrates an electronic device in different status. With reference to FIG. 3B, an angle calculated clockwise from the reference direction D_{N} to the direction D_{H} is the included angle θ^{N} between the direction D_{H} and the reference direction D_{N}. An angle calculated clockwise from the direction D_{H} to the first pointing direction D_{A} is the included angle θ^{P} between the first pointing direction D_{A} and the direction D_{H}. A sum of the included angle θ^{N} and the included angle θ^{P} is bigger than 360 degrees. In this situation, the first azimuth angle θ^{NPA} between the first pointing direction D_{A} and the reference direction D_{N} (north) can be obtained by subtracting 180 degrees from the sum of the included angle θ^{N} and the included angle θ^{P}.

FIG. 3C exemplarily illustrates a pairing method of electronic devices according to an embodiment of the invention. With reference to FIG. 1A and FIG. 3C, in the present embodiment, the touch unit 120 of the first electronic device 10 is a touch screen for detecting a drag operation M of the first touch operation. Here, the drag operation M includes a start point S and an end point E. In brief, when a user drags his or her finger or a stylus on the touch screen 120 along the trajectory of the drag operation M, the processor 140 is able to determine the first touch operation to be a drag operation with the start point S and the end point E.

According to the coordinate information of the start point S and the end point E, the processor 140 is able to obtain the first pointing direction D_{A} defined by the start point S and the end point E. In a word, the first pointing direction D_{A} may be a direction in which the drag operation M is performed. After that, the processor 140 calculates a first azimuth angle θ^{NPA} of the first pointing direction D_{A} with respect to the reference direction. As discussed above, the processor 140 is able to obtain both the reference direction of the reference direction and the direction at which the front end of the first electronic device 10 points by means of the azimuth sensor 110. Therefore, according to the information obtained by the azimuth sensor 110, the first electronic device 10 is able to calculate the first azimuth angle θ^{NPA} of the first pointing direction D_{A} with respect to the reference direction. In view of the foregoing, no matter whether the first touch operation is the point-to-click operation or the continuous drag operation, the first electronic device 10 is able to learn the corresponding first pointing direction D_{A} and further calculate the first azimuth angle θ^{NPA} of the first pointing direction D_{A} which indicates the direction at which the user points.

With reference to FIG. 1A, FIG. 1B, and FIG. 2, in step S220, the processor 140 compares the first azimuth angle θ^{NPA} with a second azimuth angle θ^{NPB} to obtain an included angle between the first pointing direction D_{A} and a second pointing direction D_{B}. The second azimuth angle θ^{NPB} is an angle of the second pointing direction D_{B} with respect to the reference direction, and the second pointing direction D_{B} is defined by the second touch operation performed on the second touch unit 220 of the second electronic device 20. As discussed above, when the pointing directions of two electronic devices are substantially opposite to each other, the two electronic devices may identify each other as the correct target to be paired. Hence, if a value obtained by subtracting 180 degrees from an absolute value of the included angle between the first pointing direction D_{A} and the second pointing direction D_{B} is smaller than a threshold θ^{TH}, the processor 140 controls the communication module 130 to establish a pairing relationship between the first electronic device 10 and the second electronic device 20.

Specifically, if the first azimuth angle θ^{NPA} and the second azimuth angle θ^{NPB} satisfy the formula |θ^{NPA}−θ^{NPB}|−180≦|θ^{TH}|, the first pointing direction D_{A} and the second pointing direction D_{B} are deemed substantially opposite to each other. Note that the threshold θ^{TH} is greater than or equal to 20 degrees and smaller than or equal to 30 degrees in an embodiment of the invention. Therefore, if the threshold θ^{TH} is greater than or equal to 20 degrees and smaller than or equal to 30 degrees, and the first and second azimuth angles θ^{NPA} and θ^{NPB} are 90 degrees and 280 degrees, respectively, the included angle between the first and second azimuth angles θ^{NPA} and θ^{NPB} is 190 degrees, and the value obtained by subtracting 180 degrees from the absolute value of the included angle between the first azimuth angle θ^{NPA} and the second azimuth angle θ^{NPB} is 10 degrees. Since 10 degrees are less than the threshold θ^{TH}, the first and second electronic devices 10 and 20 spontaneously establish the pairing relationship therebetween.

Accordingly, if the first pointing direction D_{A} of the first electronic device 10 and the second pointing direction D_{B} of the second electronic device 20 are substantially toward each other, the first and second electronic devices 10 and 20 spontaneously establish the pairing relationship therebetween and communicate with each other according to the pairing relationship, such that data may be transmitted between the first and second electronic devices 10 and 20. In brief, when the two electronic devices are to be paired, the users may individually point at the directions from themselves to the to-be-paired targets on the touch screens of the electronic devices, and thereby the pairing relationship between the two electronic devices may be spontaneously established. In the pairing method described herein, the first electronic device may receive the second azimuth angle of the second electronic device, and the first electronic device then performs steps of pairing the first and second azimuth angles. It is also likely to pair the azimuth angles by means of a remote server. Said two different embodiments will be respectively provided below.

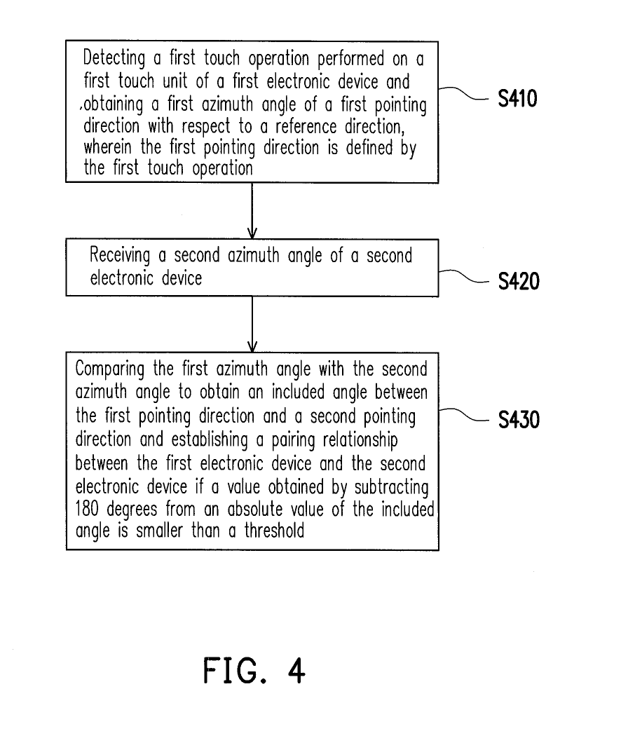

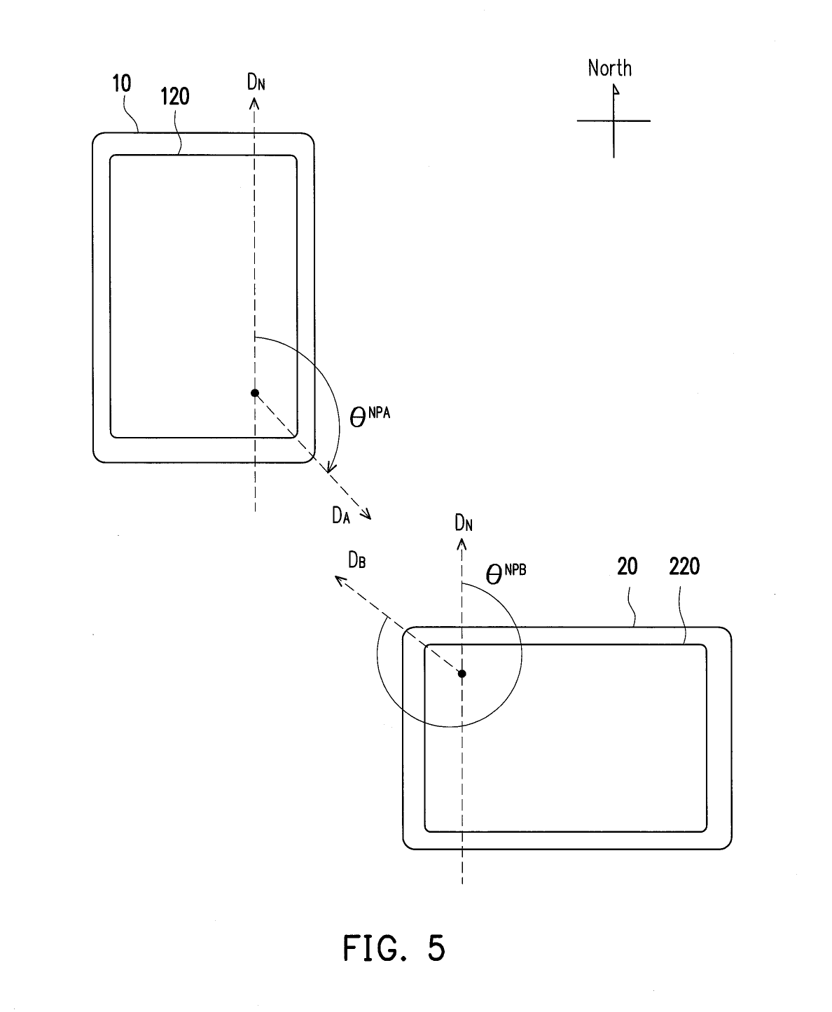

FIG. 4 is a flowchart illustrating a pairing method of electronic devices according to another embodiment of the invention. FIG. 5 exemplarily illustrates a pairing method of electronic devices according to another embodiment of the invention. With reference to FIG. 4 and FIG. 5, in the present embodiment, the electronic devices may be paired with each other according to the detected azimuth angles in no need of the remote server. Particularly, in step S410, the first electronic device 10 detects the first touch operation performed on the first touch unit 120 and obtains the first azimuth angle θ^{NPA} of the first pointing direction D_{A} with respect to the reference direction D_{N} of the reference direction. Here, the first pointing direction D_{A} is defined by the first touch operation. With reference to the descriptions shown in FIG. 1 to FIG. 3, the first electronic device 10 is capable of obtaining the first azimuth angle θ^{NPA} of the first pointing direction D_{A} according to a sensing result of the azimuth sensor, which will not be further described herein. Similarly, the second electronic device 20 is also able to obtain the second azimuth angle θ^{NPB} of the second pointing direction D_{B}.

In step S420, the first electronic device 10 receives the second azimuth angle θ^{NPB} of the second electronic device 20, i.e., the second electronic device 20 transmits the calculated second azimuth angle θ^{NPB} to the first electronic device 10. For instance, when the second electronic device 20 receives a touch operation, the second electronic device 20 is triggered to send a connection request. Through the connection request, the second electronic device 20 may directly transmit the second azimuth angle θ^{NPB} to the first electronic device 10, such that the first electronic device 10 is able to determine whether the second electronic device 20 is the correct to-be-paired target according to the first azimuth angle θ^{NPA} and the received second azimuth angle θ^{NPB}. However, the invention is not limited thereto, and the second electronic device 20 may transmit the second azimuth angle θ^{NPB} to the first electronic device 10 in a different manner.

In step S430, the first electronic device 10 compares the first azimuth angle θ^{NPA} and the second azimuth angle θ^{NPB} to obtain the included angle between the first pointing direction D_{A} and the second pointing direction D_{B}. When a value obtained by subtracting 180 degrees from an absolute value of the included angle is smaller than the threshold, the first electronic device 10 spontaneously establishes the pairing relationship between the first electronic device 10 and the second electronic device 20 For instance, as shown in FIG. 5, the first electronic device 10 receives the connection request that is sent by the second electronic device 20 and includes the second azimuth angle θ^{NPA}, and the first azimuth angle θ^{NPA} of the first pointing direction D_{A} is different from the second azimuth angle θ^{NPB} of the second pointing direction D_{B} by almost 180 degrees. Based on the difference between the second azimuth angle θ^{NPB} and the first azimuth angle θ^{NPA}, the first electronic device 10 is able to determine the second electronic device 20 to be the correct target to be paired. The first electronic device 10 then sends a connection response to the second electronic device 20; after receiving the connection response from the first electronic device 10, the second electronic device 20 considers the first electronic device 10 as the to-be-connected target. Thereafter, the first and second electronic devices 10 and 20 may transmit data therebetween through wireless connection. Here, the data transmission direction may be bidirectional or unidirectional, which should not be construed as a limitation to the invention.

Specifically, if the first and second electronic devices 10 and 20 are both capable of Bluetooth transmission, the first electronic device 10 may search any Bluetooth device nearby as the to-be-connected target. If a Bluetooth device pointing at a direction opposite to that of the first electronic device 10 is found, the first electronic device 10 considers the Bluetooth device (i.e., the second electronic device 20) as the to-be-connected target and establishes a Bluetooth connection with the second electronic device 20.

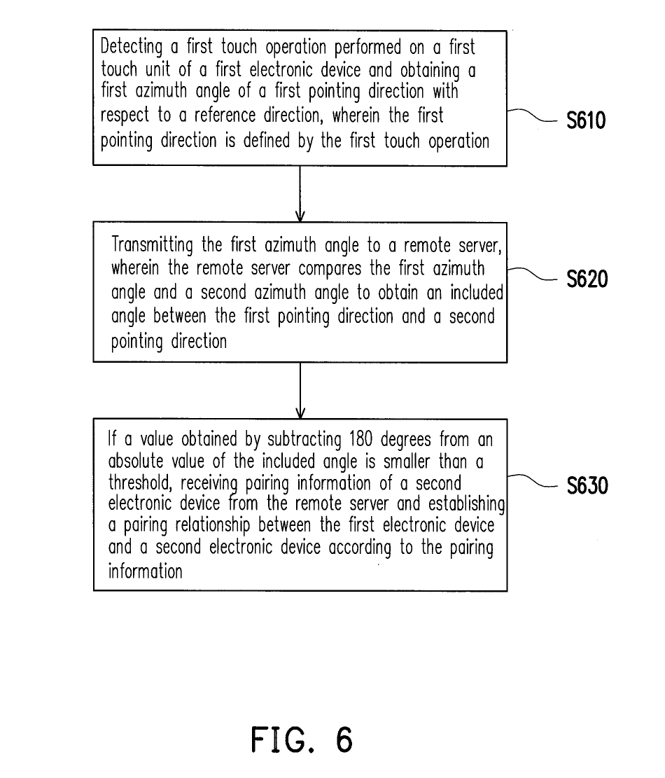

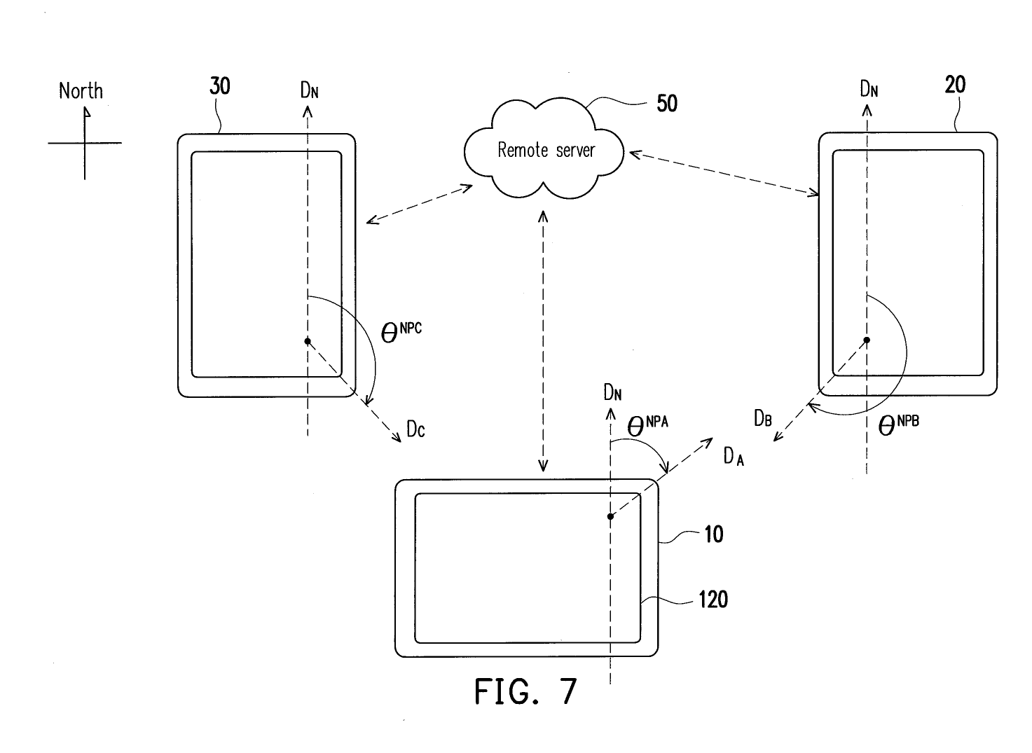

On the other hand, the electronic device may also transmit its azimuth angle to a remote server through wireless WAN, e.g., 3G network or 4G network, such that the remote server is able to compare and pair the received azimuth angles. FIG. 6 is a flowchart illustrating a pairing method of electronic devices according to yet another embodiment of the invention. FIG. 7 exemplarily illustrates a pairing method of electronic devices according to yet another embodiment of the invention.

With reference to FIG. 6 and FIG. 7, in step S610, the first electronic device 10 detects the first touch operation performed on the first touch unit 120 and obtains the first azimuth angle θ^{NPA} of the first pointing direction D_{A} with respect to the reference direction D_{N} of the reference direction. Here, the first pointing direction D_{A} is defined by the first touch operation. Similarly, the second electronic device 20 may obtain the second azimuth angle θ^{NPB} of the second pointing direction D_{B}, and a third electronic device 30 may obtain a third azimuth angle θ^{NPC} of a third pointing direction D_{C}.

In step S620, the first electronic device 10 transmits the first azimuth angle θ^{NPA} to the remote server 50. The remote server 50 compares the first azimuth angle θ^{NPA} and the second azimuth angle θ^{NPB} to obtain the included angle between the first pointing direction D_{A} and the second pointing direction D_{B}. Particularly, in addition to the first electronic device 10, the second electronic device 20 transmits the second azimuth angle θ^{NPB} to the remote server 50, and the third electronic device 30 also transmits the third azimuth angle θ^{NPC} to the remote server 50. Within a predetermined time frame, the remote server 50 receives a plurality of azimuth angle information. Here, the predetermined time frame may be set up according to actual requirements and should not be construed as a limitation to the invention. In the present embodiment, the remote server 50 receives the first azimuth angle θ^{NPA}, the second azimuth angle θ^{NPB}, and the third azimuth angle θ^{NPC}.

The remote server 50 then compares the first azimuth angle θ^{NPA}, the second azimuth angle θ^{NPB}, and the third azimuth angle θ^{NPC}, so as to obtain the included angle among the three azimuth angles. As shown in FIG. 7, through the calculation of the included angle among the three azimuth angles, it can be learned that the first pointing direction D_{A} and the second pointing direction D_{B} are opposite to each other, and the third pointing direction D_{C} is neither opposite to the first pointing direction D_{A} nor opposite to the second pointing direction D_{B}. Hence, if the value obtained by subtracting 180 degrees from the absolute value of the included angle between the first azimuth angle θ^{NPA} and the second azimuth angle θ^{NPB} is smaller than the threshold, the first electronic device 10 receives pairing information of the second electronic device 20 from the remote server 50 and establishes the pairing relationship between the first electronic device 10 and the second electronic device 20 according to the pairing information.

To be specific, after the remote server 50 receives the azimuth angles and the device information transmitted by the electronic devices, the remote server is able to pair the electronic devices according to the geographic locations of the electronic devices, the time at which the azimuth angles are received, and the information relevant to the received azimuth angles. In an embodiment of the invention, the remote server 50 may pair the two electronic devices which are geographically close to each other, transmit the azimuth angle approximately at the same time, and respectively have the azimuth angles differing from each other by 180 degrees. The remote server 50 then transmits the pairing information of one electronic device (e.g., the device information of the electronic device, the network address, and so on) to the other electronic device which is successfully paired with the one electronic device. For instance, if the first and second electronic devices 10 and 20 both support Bluetooth wireless communication technology, the remote server 50 may, after successfully pairing the first and second electronic devices 10 and 20, automatically transmit the media access control (MAC) address of the second electronic device 20 to the first electronic device 10 or transmit the MAC address of the first electronic device 10 to the second electronic device 20. Thereby, one electronic device receiving the pairing information from the remote server 50 may automatically establish a pairing relationship with another electronic device.

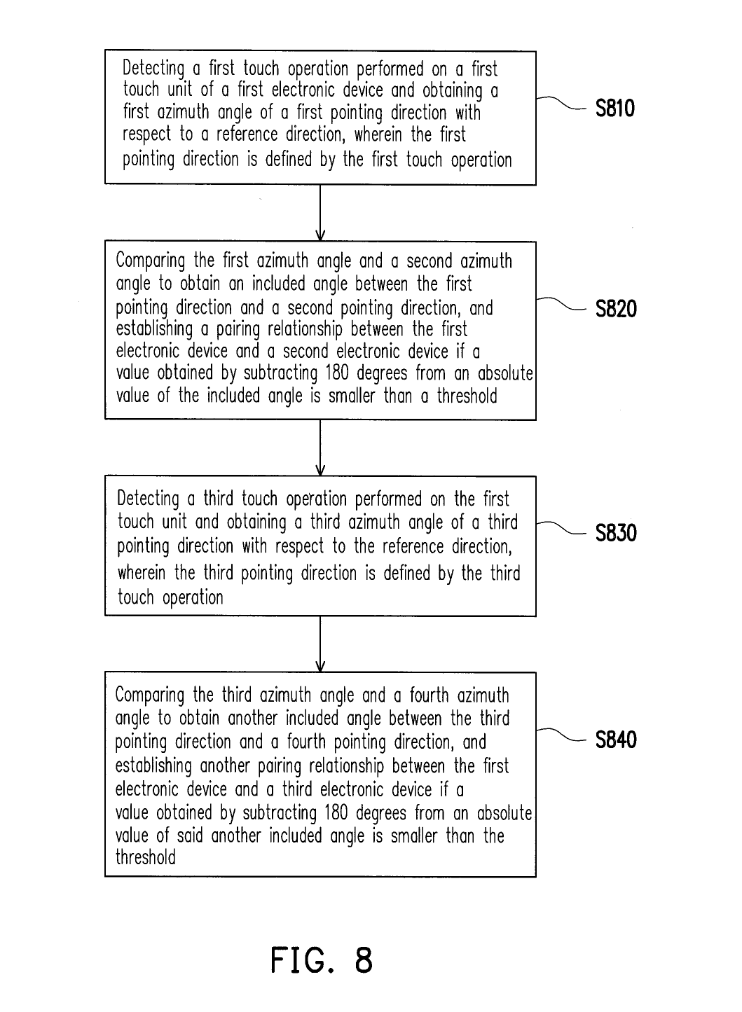

Note that the pairing method described herein may be performed on a one-to-one basis, a one-to-many basis, or a many-to-many basis. That is, in the pairing process by means of the pointing directions, the electronic device can be paired with another electronic device or can be simultaneously paired with multiple mobile electronic devices. FIG. 8 is a flowchart illustrating a pairing method of electronic devices according to yet another embodiment of the invention. With reference to FIG. 8, the pairing method of the electronic device includes following steps.

In step S810, a first touch operation performed on a first touch unit of a first electronic device is detected, and a first azimuth angle of a first pointing direction with respect to a reference direction is obtained. Here, the first pointing direction is defined by the first touch operation. In step S820, the first azimuth angle and a second azimuth angle are compared to obtain an included angle between the first pointing direction and a second pointing direction. If a value obtained by subtracting 180 degrees from an absolute value of the included angle is smaller than a threshold, a pairing relationship is established between the first electronic device and a second electronic device. The second azimuth angle is an azimuth angle of the second pointing direction with respect to the reference direction, and the second pointing direction is defined by the second touch operation performed on a second touch unit of the second electronic device.

In step S830, a third touch operation performed on the first touch unit is detected, and a third azimuth angle of a third pointing direction with respect to a reference direction is obtained. Here, the third pointing direction is defined by the third touch operation. In step S840, the third azimuth angle and a fourth azimuth angle are compared to obtain another included angle between the third pointing direction and a fourth pointing direction. If a value obtained by subtracting 180 degrees from an absolute value of said another included angle is smaller than the threshold, another pairing relationship between the first electronic device and a third electronic device is established. The fourth azimuth angle is an azimuth angle of the fourth pointing direction with respect to the reference direction, and the fourth pointing direction is defined by the fourth touch operation performed on a third touch unit of the third electronic device. According to said pairing method, the pairing relationship between the first electronic device and the second electronic device is established, and so is the pairing relationship between the first and third electronic devices. In brief, each electronic device may be connected to another electronic device by means of the user's touch operation that contains the point information. As such, through said simple control, the electronic devices may be connected to one another for sharing information.

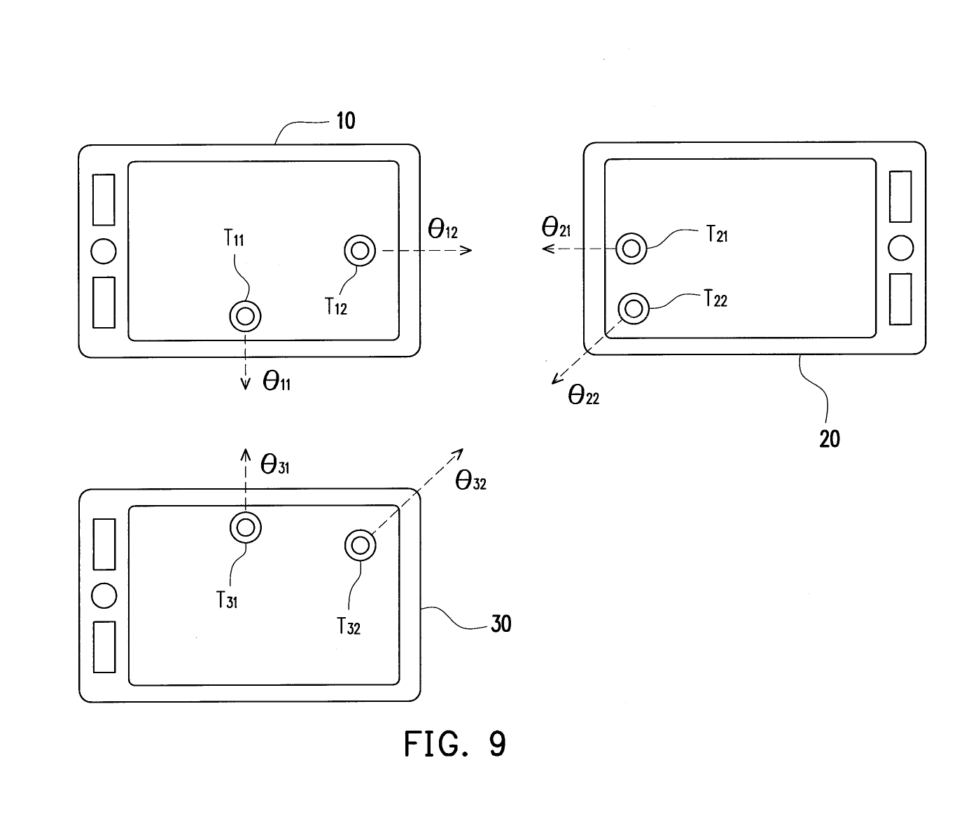

FIG. 9 exemplarily illustrates a pairing method of electronic devices according to yet another embodiment of the invention. With reference to FIG. 9, as described above, since the electronic device 10 receives the touch operations T₁₁ and T₁₂ input by the user, the corresponding azimuth angles θ₁₁ and θ₁₂ are defined. Similarly, since the electronic device 20 receives the touch operations T₂₁ and T₂₂ input by the user, the corresponding azimuth angles θ₂₁ and θ₂₂ are defined; since the electronic device 30 receives the touch operations T₃₁ and T₃₂ input by the user, the corresponding azimuth angles θ₃₁ and θ₃₂ are defined. Note that the electronic devices respectively define the azimuth angles based on the same reference direction. Hence, in case of the same reference direction, the remote server or the electronic devices may determine whether the included angle between the azimuth angles is close to 180 degrees, so as to learn whether the corresponding pointing directions are substantially opposite to each other.

According to the present embodiment, after the electronic device 10 receives the touch operations T₁₁ and T₁₂, the electronic device 10 may transmit the calculated azimuth angles θ₁₁ and θ₁₂ to the remote server. Similarly, after the electronic device 20 receives the touch operations T₂₁ and T₂₂, the electronic device 20 may transmit the calculated azimuth angles θ₂₁ and θ₂₂ to the remote server; after the electronic device 30 receives the touch operations T₃₁ and T₃₂, the electronic device 30 may transmit the calculated azimuth angles θ₃₁ and θ₃₂ to the remote server. Within a certain time frame, the remote server is able to collect the azimuth angles transmitted by each electronic device and calculate the relative included angle between the azimuth angles, so as to determine the azimuth angles which differ from each other by approximately 180 degrees.

As shown in FIG. 9, the azimuth angles θ₁₁ and θ₃₁ differ from each other by approximately 180 degrees, the remote server considers the electronic devices 10 and 30 as the successfully paired electronic devices. Therefore, the remote server transmits the pairing information of the electronic devices 10 and 30 to the electronic devices 30 and 10, respectively. According to the pairing information, the electronic devices 10 and 30 are able to establish the pairing relationship with each other and further share data. Similarly, the electronic devices 10 and 20 are able to establish the pairing relationship with each other according to the pairing information sent by the remote server, and so are the electronic devices 20 and 30. It can be concluded that the pairing method described herein is not limited to be performed in a one-to-one manner. By means of the remote server which receives and calculates the azimuth angles transmitted by the electronic devices, the pairing method may also be performed in a many-to-many manner.

To sum up, the pairing relationship between the electronic devices may be established by means of the user's touch operation which contains the point information. That is, users are able to establish the pairing relationship between their electronic devices by performing the touch operations (containing the point information) on their electronic devices. The establishment of the pairing relationship is based on the azimuth angle corresponding to the touch operation; thereby, the complicated set-up process may be simplified, the possible errors occurring in the connection and pairing process may be reduced, and the use of the electronic device becomes more convenient and intuitive. Moreover, in an embodiment of the invention, the pairing method is performed in a one-to-one manner; in another embodiment, the pairing relationship among multiple electronic devices may be established, such that data may be easily transmitted among the electronic devices by performing simple steps. Since users are not required to manually perform additional set-ups, the data sharing efficiency may be ameliorated.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A pairing method of electronic devices, the pairing method comprising:
detecting a first touch operation performed on a first touch unit of a first electronic device and obtaining a first azimuth angle of a first pointing direction with respect to a reference direction, wherein the first pointing direction is defined by the first touch operation; and
comparing the first azimuth angle with a second azimuth angle to obtain an included angle between the first pointing direction and a second pointing direction, and establishing a pairing relationship between the first electronic device and a second electronic device if a value obtained by subtracting 180 degrees from an absolute value of the included angle is smaller than a threshold,
wherein the second azimuth angle is an azimuth angle of the second pointing direction with respect to the reference direction, and the second pointing direction is defined by a second touch operation performed on a second touch unit of the second electronic device.

2. The pairing method as recited in claim 1, wherein the step of detecting the first touch operation performed on the first touch unit and obtaining the first azimuth angle of the first pointing direction with respect to the reference direction comprises:
detecting a touch point of the first touch operation;
obtaining the first pointing direction defined by the touch point of the first touch operation and a reference point; and
calculating the first azimuth angle of the first pointing direction with respect to the reference direction.

3. The pairing method as recited in claim 1, wherein the step of detecting the first touch operation performed on the first touch unit and obtaining the first azimuth angle of the first pointing direction with respect to the reference direction comprises:
detecting a drag operation of the first touch operation, wherein the drag operation comprises a start point and an end point;
obtaining the first pointing direction defined by the start point and the end point; and
calculating the first azimuth angle of the first pointing direction with respect to the reference direction.

4. The pairing method as recited in claim 1, before the step of comparing the first azimuth angle with the second azimuth angle to obtain the included angle between the first pointing direction and the second pointing direction and establishing the pairing relationship between the first electronic device and the second electronic device if the value obtained by subtracting 180 degrees from the absolute value of the included angle is smaller than the threshold, the pairing method further comprising:
receiving the second azimuth angle of the second electronic device.

5. The pairing method as recited in claim 1, wherein the step of comparing the first azimuth angle with the second azimuth angle to obtain the included angle between the first pointing direction and the second pointing direction and establishing the pairing relationship between the first electronic device and the second electronic device if the value obtained by subtracting 180 degrees from the absolute value of the included angle is smaller than the threshold comprises:
transmitting the first azimuth angle to a remote server, wherein the remote server compares the first azimuth angle with the second azimuth angle to obtain the included angle between the first pointing direction and the second pointing direction; and
if the value obtained by subtracting 180 degrees from the absolute value of the included angle is smaller than the threshold, receiving pairing information of the second electronic device from the remote server and establishing the pairing relationship between the first electronic device and the second electronic device according to the pairing information.

6. The pairing method as recited in claim 1, further comprising:
detecting a third touch operation performed on the first touch unit and obtaining a third azimuth angle of a third pointing direction with respect to the reference direction, wherein the third pointing direction is defined by the third touch operation; and
comparing the third azimuth angle with a fourth azimuth angle to obtain another included angle between the third pointing direction and a fourth pointing direction, and establishing another pairing relationship between the first electronic device and a third electronic device if a value obtained by subtracting 180 degrees from an absolute value of the another included angle is smaller than the threshold,
wherein the fourth azimuth angle is an azimuth angle of the fourth pointing direction with respect to the reference direction, and the fourth pointing direction is defined by a fourth touch operation performed on a third touch unit of the third electronic device.

7. The pairing method as recited in claim 1, wherein the threshold is greater than or equal to 20 degrees and smaller than or equal to 30 degrees.

8. An electronic device comprising:
an azimuth sensor configured to sense a reference direction;
a touch unit configured to detect a first touch operation performed on the touch unit;
a processor coupled to the touch unit and the azimuth sensor, the processor obtaining a first azimuth angle of a first pointing direction with respect to a reference direction and comparing the first azimuth angle with a second azimuth angle to obtain an included angle between the first pointing direction and a second pointing direction, wherein the first pointing direction is defined by the first touch operation; and
a communication module coupled to the processor, if a value obtained by subtracting 180 degrees from an absolute value of the included angle is smaller than a threshold, the processor controlling the communication module to establish a pairing relationship between the electronic device and a second electronic device, wherein the second azimuth angle is an azimuth angle of the second pointing direction with respect to the reference direction, and the second pointing direction is defined by a second touch operation performed on a second touch unit of the second electronic device.

9. The electronic device as recited in claim 8, wherein the processor detects a touch point of the first touch operation and obtains the first pointing direction defined by the touch point of the first touch operation and a reference point, and the processor calculates the first azimuth angle of the first pointing direction with respect to the reference direction.

10. The electronic device as recited in claim 8, wherein the processor detects a drag operation of the first touch operation, the drag operation comprises a start point and an end point, and the processor obtains the first pointing direction defined by the start point and the end point and calculates the first azimuth angle of the first pointing direction with respect to the reference direction.

11. The electronic device as recited in claim 8, wherein the processor receives the second azimuth angle of the second electronic device through the communication module.

12. The electronic device as recited in claim 8, wherein the processor transmits the first azimuth angle to a remote server through the communication module, the remote server compares the first azimuth angle with the second azimuth angle to obtain the included angle between the first pointing direction and the second pointing direction, and if the value obtained by subtracting 180 degrees from the absolute value of the included angle is smaller than the threshold, the processor receives pairing information of the second electronic device from the remote server through the communication module and establishes the pairing relationship between the electronic device and the second electronic device according to the pairing information.

13. The electronic device as recited in claim 8, wherein the touch unit further detects a third touch operation performed on the touch unit, the processor obtains a third azimuth angle of a third pointing direction with respect to the reference direction and compares the third azimuth angle with a fourth azimuth angle to obtain another included angle between the third pointing direction and a fourth pointing direction, and if a value obtained by subtracting 180 degrees from an absolute value of the another included angle is smaller than the threshold, the processor controls the communication module to establish another pairing relationship between the electronic device and a third electronic device, wherein the third pointing direction is defined by the third touch operation, the fourth azimuth angle is an azimuth angle of the fourth pointing direction with respect to the reference direction, and the fourth pointing direction is defined by the fourth touch operation performed on a third touch unit of the third electronic device.

14. The electronic device as recited in claim 8, wherein the threshold is greater than or equal to 20 degrees and smaller than or equal to 30 degrees.
